(19) United States
(12) Patent Application Publication
(10) Pub. No.: US 2026/0124724 A1
(43) Pub. Date: May 7, 2026

(54) ELECTRIC TOOL SYSTEM, DIAGNOSIS METHOD, AND PROGRAM

(71) Applicant: PANASONIC HOLDINGS CORPORATION, Osaka (JP)

(72) Inventors: Keita OKAMOTO, Mie (JP); Masaki IKEDA, Shiga (JP); Koichi HASHIMOTO, Shiga (JP)

(21) Appl. No.: 18/874,461

(22) PCT Filed: Jun. 21, 2023
(86) PCT No.: PCT/JP2023/022997

§ 371 Date: Dec. 12, 2024

(30) Foreign Application Priority Data
Jul. 4, 2022 (JP) 2022-107897

(51) Int. Cl. B25B 23/147; B25F 5/00

(52) U.S. Cl. CPC B25B 23/1475; B25F 5/00

(57) ABSTRACT

An electric tool system includes an electric tool section, a measuring unit, a storage unit, and a decision unit. The measuring unit measures a physical quantity concerning the electric tool section. The storage unit stores the physical quantity measured by the measuring unit. The decision unit determines, based on the physical quantity stored in the storage unit, whether the tip tool needs replacement or not and thereby obtains replacement information representing a decision result indicating whether the tip tool needs replacement or not.

### TECHNICAL FIELD

The present disclosure generally relates to an electric tool system, a diagnosis method, and a program. More particularly, the present disclosure relates to an electric tool system, a diagnosis method, and a program, all of which are configured or designed to obtain information about a tip tool to be attached to an electric tool section.

### BACKGROUND ART

Patent Literature 1 discloses an electric tool including a motor, an acquisition unit, a storage unit, and a transmission unit. The acquisition unit acquires physical quantity data detected while the motor is running. The storage unit stores the physical quantity data in association with time information about a time when the physical quantity data is acquired. The transmission unit transmits the physical quantity data and the time information to a server system. The server system evaluates the current condition of the electric tool by the physical quantity data and the time information.

### CITATION LIST

### Patent Literature

Patent Literature 1: JP 2020-038580 A

### SUMMARY OF INVENTION

An object of the present disclosure is to provide an electric tool system, a diagnosis method, and a program, all of which make it easier for a user, for example, to determine whether any decline has been caused in the efficiency of operations being performed using an electric tool section.

An electric tool system according to an aspect of the present disclosure includes an electric tool section, a measuring unit, a storage unit, and a decision unit. The electric tool section is portable. The electric tool section includes a driving part, an attachment part, and a transmission part. The driving part is supplied with motive power by a power source and thereby generates torque. A tip tool is attachable to the attachment part. The transmission part transmits the torque from the driving part to the attachment part and thereby drives the attachment part. The measuring unit measures a physical quantity concerning the electric tool section. The storage unit stores the physical quantity measured by the measuring unit. The decision unit determines, based on the physical quantity stored in the storage unit, whether the tip tool needs replacement or not and thereby obtains replacement information representing a decision result indicating whether the tip tool needs replacement or not.

A diagnosis method according to another aspect of the present disclosure is a method for making a diagnosis about an electric tool section which is portable. The electric tool section includes a driving part, an attachment part, and a transmission part. The driving part is supplied with motive power by a power source and thereby generates torque. A tip tool is attachable to the attachment part. The transmission part transmits the torque from the driving part to the attachment part and thereby drives the attachment part. The diagnosis method includes a storing step and a decision step. The storing step includes storing, in a storage unit, a physical quantity concerning the electric tool section which has been measured by a measuring unit. The decision step includes determining, based on the physical quantity stored in the storage unit, whether the tip tool needs replacement or not and thereby obtaining replacement information representing a decision result indicating whether the tip tool needs replacement or not.

A program according to still another aspect of the present disclosure is designed to cause one or more processors of a computer system to perform the diagnosis method described above.

### BRIEF DESCRIPTION OF DRAWINGS

FIG. 1 is a block diagram of an electric tool system according to an exemplary embodiment;

FIG. 2 is a perspective view of an electric tool section of the electric tool system:

FIG. 3 is a schematic representation of the electric tool section of the electric tool system:

FIG. 4 is a schematic representation showing the concept of a decision range in the electric tool section two-dimensionally:

FIG. 5 is a flowchart showing the procedure of operation of the electric tool section of the electric tool system; and

FIG. 6 is a flowchart showing the procedure of operation of a linkage device included in the electric tool system.

### DESCRIPTION OF EMBODIMENTS

### Embodiment

An electric tool system 100, a diagnosis method, and a program according to an exemplary embodiment will be described with reference to the accompanying drawings. Note that the embodiment to be described below is only an exemplary one of various embodiments of the present disclosure and should not be construed as limiting. Rather, the exemplary embodiment may be readily modified in various manners depending on a design choice or any other factor without departing from the scope of the present disclosure. The drawings to be referred to in the following description of embodiments are all schematic representations. Thus, the ratio of the dimensions (including thicknesses) of respective constituent elements illustrated on the drawings does not always reflect their actual dimensional ratio.

### Overview

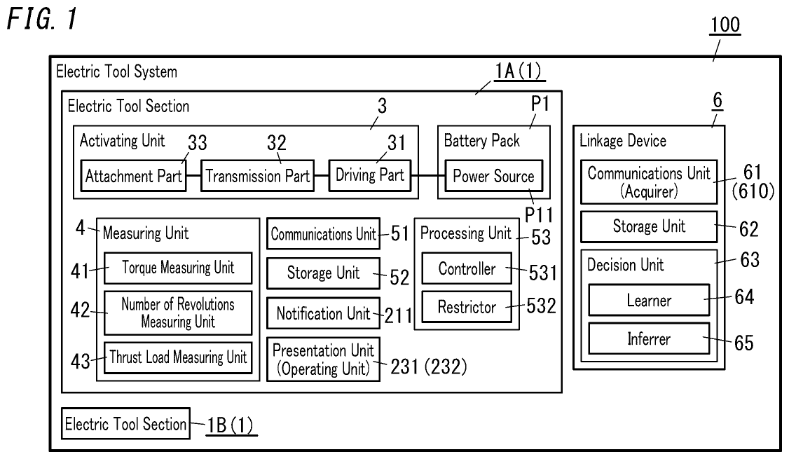

As shown in FIG. 1, an electric tool system 100 according to an exemplary embodiment includes an electric tool section 1, a measuring unit 4, a storage unit 62, and a decision unit 63. The electric tool section 1 is portable. The electric tool section 1 includes a driving part 31, an attachment part 33, and a transmission part 32. The driving part 31 is supplied with motive power by a power source P11 and thereby generates torque. A tip tool is attachable to the attachment part 33. The transmission part 32 transmits the torque from the driving part 31 to the attachment part 33 and thereby drives the attachment part 33. The measuring unit 4 measures a physical quantity concerning the electric tool section 1. The storage unit 62 stores the physical quantity measured by the measuring unit 4. The decision unit 63 determines, based on the physical quantity stored in the storage unit 62, whether the tip tool needs replacement or not and thereby obtains replacement information representing a decision result indicating whether the tip tool needs replacement or not.

This embodiment allows the user, for example, to determine, by reference to the replacement information, whether the wear of the tip tool, for example, has caused any decline in the efficiency of operations being performed using the electric tool section 1, thus reducing the chances of causing a decline in the efficiency of operations.

Optionally, the functions of the electric tool system 100 may also be implemented as a diagnosis method. A diagnosis method according to an exemplary embodiment is a method for making a diagnosis about an electric tool section 1 which is portable. The electric tool section 1 includes a driving part 31, an attachment part 33, and a transmission part 32. The driving part 31 is supplied with motive power by a power source P11 and thereby generates torque. A tip tool is attachable to the attachment part 33. The transmission part 32 transmits the torque from the driving part 31 to the attachment part 33 and thereby drives the attachment part 33. The diagnosis method includes a storing step and a decision step. The storing step includes storing, in a storage unit 62, a physical quantity concerning the electric tool section 1 which has been measured by a measuring unit 4. The decision step includes determining, based on the physical quantity stored in the storage unit 62, whether the tip tool needs replacement or not and thereby obtaining replacement information representing a decision result indicating whether the tip tool needs replacement or not.

Furthermore, the diagnosis method may also be implemented as a program. A program according to an exemplary embodiment is designed to cause one or more processors of a computer system to perform the diagnosis method described above. The program may be stored in a non-transitory storage medium, which is readable for a computer system.

### Details

### (1) Overall Configuration

The electric tool system 100 will now be described in further detail.

As shown in FIG. 1, the electric tool system 100 includes an electric tool section 1 and a linkage device 6

The electric tool section 1 is a device to which a tip tool is attachable. Examples of the tip tool include a drill bit and a screwdriver bit. The user (operator) uses the electric tool section 1 for the purpose of performing the operations of drilling a hole or fastening a screw, for example. The electric tool section 1 is also a portable device (handheld device).

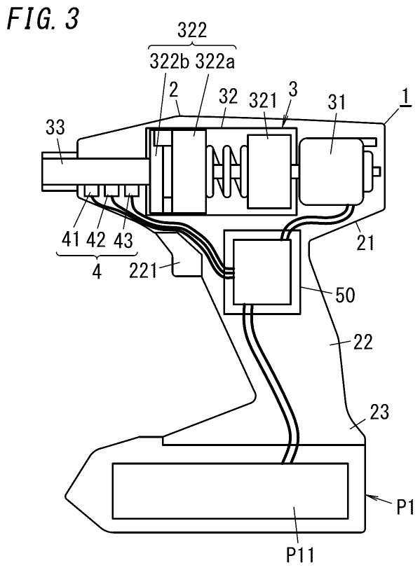

The electric tool section 1 also includes an impact mechanism 322 (refer to FIG. 3) for applying impacting force (impact) to the attachment part 33 using the torque applied by the driving part 31. That is to say, the electric tool section 1 is an impact tool.

The linkage device 6 includes a computer system. The linkage device 6 may be, for example, an industrial computer, a personal computer, a tablet computer, or a cellphone such as a smartphone. The linkage device 6 communicates with the electric tool section 1. The linkage device 6 processes the information acquired from the electric tool section 1, thereby obtaining replacement information.

In particular, in the following description of embodiments, the electric tool system 100 is supposed to be used on an assembly line where a plurality of users perform the operations of assembling a plurality of workpieces. The electric tool system 100 includes a plurality of (e.g., two in the example shown in FIG. 1) electric tool sections 1. One electric tool section 1A out of the two electric tool sections 1 is used by a first user, while the other electric tool section 1B is used by a second user different from the first user. These two electric tool sections 1A, 1B have the same configuration. Thus, the following description will be focused on the one electric tool section 1A unless otherwise stated.

### (2) Electric Tool Section

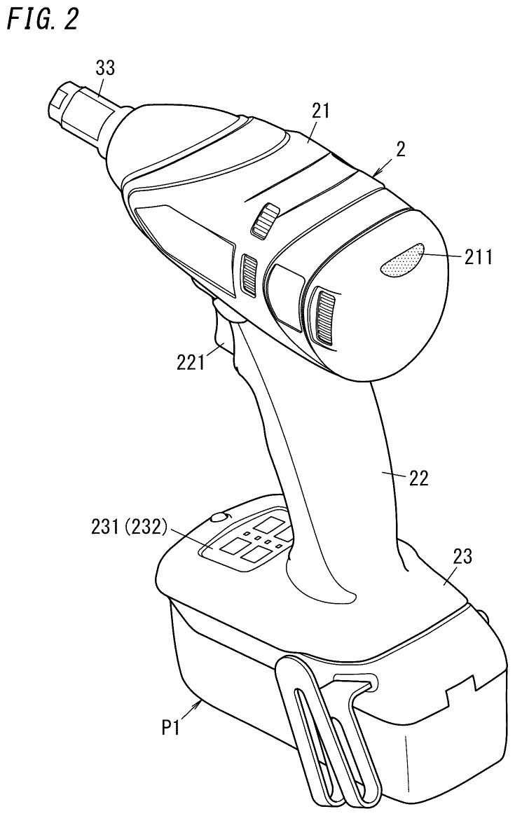

As shown in FIG. 1, the electric tool section 1 includes an activating unit 3, a battery pack P1, the measuring unit 4, a communications unit 51, a storage unit 52, a processing unit 53, a notification unit 211, and a presentation unit 231. The activating unit 3 includes the attachment part 33, the transmission part 32, and the driving part 31. Also, as shown in FIGS. 2 and 3, the electric tool section 1 further includes a housing 2, a trigger switch 221, and a box 50.

### (3) Housing

The housing 2 houses the transmission part 32, the driving part 31, the measuring unit 4, the processing unit 53, and other members. The housing 2 includes a housing portion 21, a grip portion 22, and an attachment portion 23.

The housing portion 21 has a cylindrical shape. The housing portion 21 houses the transmission part 32, the driving part 31, the measuring unit 4, and other members.

The notification unit 211 is held on the surface of the housing portion 21. Examples of the notification unit 211 include a light-emitting diode (LED). The notification unit 211 is provided at an end, opposite from the attachment part 33, of the housing portion 21 to allow the user to visually recognize the notification unit 211 easily while performing the operations (refer to FIG. 2). The notification unit 211 notifies the user, by turning ON or flashing, for example, under the control of the processing unit 53 to prompt him or her to replace the tip tool.

The grip portion 22 protrudes in one direction aligned with the radius of the housing portion 21 from an outer peripheral surface of the housing portion 21. The grip portion 22 is formed in the shape of a hollow cylinder elongate in the one direction. The grip portion 22 is a part to be held by the user while performing the operations of fastening a screw, for example. The trigger switch 221 is held by the grip portion 22. The trigger switch 221 is a switch for use to control the ON/OFF states of the driving part 31.

The housing portion 21 is connected to one longitudinal end (i.e., the upper end in FIG. 2) of the grip portion 22. The attachment portion 23 is connected to the other longitudinal end (i.e., the lower end in FIG. 2) of the grip portion 22.

In addition, the box 50 (refer to FIG. 3) is further housed in the grip portion 22. The box 50 houses, for example, the communications unit 51 (refer to FIG. 1), the storage unit 52, and the processing unit 53.

The battery pack P1 is attached removably to the attachment portion 23. In this embodiment, the battery pack P1 is supposed to be one of the constituent elements of the electric tool section 1. However, the battery pack P1 may also be counted out of the constituent elements of the electric tool section 1.

The battery pack P1 includes, as the power source P11, either a primary battery or a secondary battery. The electric tool section 1 is activated with the electric power supplied from the power source P11. That is to say, the power source P11 supplies electric power for driving the driving part 31 (motor). In addition, the power source P11 also supplies electric power for activating the communications unit 51, the processing unit 53, and other components.

In addition, the presentation unit 231 is held by the attachment portion 23. The presentation unit 231 includes a display device such as a display for providing visually notification of information, for example. The presentation unit 231 is also integrated with an operating unit 232. The operating unit 232 may include, for example, a plurality of buttons. The operating unit 232 accepts an operating command entered by the user. The user may check various statuses of the electric tool section 1 by using the presentation unit 231. For example, the user may check the operation mode of the electric tool section 1 using the presentation unit 231. In addition, the user may also make various settings about the electric tool section 1 using the operating unit 232. For example, the user may change the operation mode of the electric tool section 1 using the presentation unit 231.

### (4) Driving Part

The driving part 31 shown in FIG. 3 may be, for example, a servo motor. The driving part 31 transforms the electrical energy supplied from the power source P11 into torque. The torque and the number of revolutions of the driving part 31 vary under the control of a controller 531 (refer to FIG. 1). The controller 531 is a servo driver. The controller 531 controls the operation of the driving part 31 by performing, for example, feedback control for bringing the torque and number of revolutions of the driving part 31 closer toward target values.

The controller 531 (refer to FIG. 1) detects the manipulative variable of the trigger switch 221 (i.e., how deep the trigger switch 221 has been pulled) and controls the driving part 31 according to the manipulative variable. When the trigger switch 221 is pulled by the user, the driving part 31 is activated with the motive power supplied from the power source P11, thus generating torque. In addition, the controller 531 adjusts the target value of the number of revolutions of the driving part 31 (motor) in accordance with the manipulative variable of the trigger switch 221.

### (5) Transmission Part

The transmission part 32 transmits the torque of the driving part 31 to the attachment part 33. This causes the attachment part 33 to rotate.

The transmission part 32 may include, for example, a planetary gear mechanism 321 and the impact mechanism 322. The planetary gear mechanism 321 is a speed reducer. That is to say, the transmission part 32 causes the attachment part 33 to rotate at a smaller number of revolutions than the number of revolutions of the driving part 31.

The impact mechanism 322 is driven with the motive power of the driving part 31. As shown in FIG. 3, the impact mechanism 322 may include, for example, a hammer 322a supported rotatably by the drive shaft and an anvil 322b connected to a rear end portion of the attachment part 33. The hammer 322a applies impacting force to the anvil 322b using the torque transmitted from the driving part 31.

When the torque applied to the tip tool exceeds a predetermined level, the impact mechanism 322 applies impact to the attachment part 33 in the rotational direction. This allows the tip tool to apply greater torque to the work target such as a screw.

### (6) Attachment Part

A tip tool is attached to the attachment part 33. Examples of the tip tool include a drill bit and a screwdriver bit. Any of various types of tip tools may be attached to the attachment part 33 depending on the intended use. Alternatively, only a particular tip tool may be attached to the attachment part 33.

As the torque is transmitted from the driving part 31 to the attachment part 33 via the transmission part 32, the tip tool rotates along with the attachment part 33. This allows the user to perform operations such as drilling a hole or fastening a screw using the electric tool section 1.

### (7) Measuring Unit

The measuring unit 4 measures a physical quantity concerning the electric tool section 1. More specifically, the measuring unit 4 measures a physical quantity concerning the operation of the tip tool. The measuring unit 4 according to this embodiment includes a torque measuring unit 41, a number of revolutions measuring unit 42, and a thrust load measuring unit 43.

The torque measuring unit 41 measures, as the physical quantity, torque applied to the tip tool. More specifically, the torque measuring unit 41 measures, as a physical quantity corresponding to the torque applied to the tip tool, the torque applied to the attachment part 33.

The torque measuring unit 41 may include, for example, a magnetostrictive strain sensor or a resistive strain sensor.

The magnetostrictive strain sensor makes a coil, which is disposed in a non-rotating part in the vicinity of the attachment part 33, detect a variation in magnetic permeability responsive to the strain caused upon the application of torque to the attachment part 33 and outputs a voltage signal proportional to the strain.

The resistive strain sensor is affixed onto the surface of the attachment part 33. The resistive strain sensor transforms a variation in electrical resistance value responsive to the strain caused upon the application of the torque to the attachment part 33 into a voltage signal and outputs the voltage signal.

The number of revolutions measuring unit 42 measures, as the physical quantity, the number of revolutions of the tip tool. In this embodiment, the number of revolutions of the tip tool agrees with the number of revolutions of the attachment part 33 and the number of revolutions measuring unit 42 measures the number of revolutions of the attachment part 33. As the number of revolutions measuring unit 42, a photoelectric encoder or a magnetic encoder may be adopted, for example.

The thrust load measuring unit 43 measures, as the physical quantity, the thrust load applied to the tip tool. As used herein, the thrust load refers to a load applied in a direction aligned with the rotational axis of the attachment part 33. The thrust load is a physical quantity depending on, for example, the magnitude of the force with which the user thrusts the tip tool against the work target. In this embodiment, the thrust load measuring unit 43 measures, as a physical quantity corresponding to the thrust load applied to the tip tool, the thrust load applied to the attachment part 33. The thrust load measuring unit 43 may include, for example, a pressure sensor such as a strain gauge attached to the attachment part 33.

### (8) Communications Unit

The communications unit 51 (refer to FIG. 1) includes a communications interface device. The communications unit 51 is ready to communicate with the communications unit 61 of the linkage device 6 via the communications interface device. As used herein, the phrase “to be ready to communicate” means being able to transmit and receive signals either directly or indirectly via a network or a repeater, for example, by an appropriate wired or wireless communication method.

### (9) Storage Unit

The storage unit 52 (refer to FIG. 1) is a nonvolatile storage device which may be implemented as, for example, a hard disk drive (HDD) or a solid-state drive (SSD). The storage unit 52 stores the physical quantity measured by the measuring unit 4.

### (10) Processing Unit

The electric tool section 1 includes a computer system including one or more processors and a memory. The processing unit 53 (refer to FIG. 1) includes the one or more processors of the electric tool section 1. The functions of the processing unit 53 are performed by making the one or more processors of the processing unit 53 execute a program stored in the memory. The program may be stored in the memory. Alternatively, the program may also be downloaded via a telecommunications line such as the Internet or distributed after having been stored in a non-transitory storage medium such as a memory card.

As shown in FIG. 1, the processing unit 53 includes the controller 531 and a restrictor 532. Note that these constituent elements only represent the respective functions to be performed by the processing unit 53 and do not necessarily have a substantive configuration.

The controller 531 detects the manipulative variable of the trigger switch 221 (refer to FIG. 2) to control the number of revolutions of the driving part 31 according to the manipulative variable.

As described above, the notification unit 211 makes notification, under the control of the processing unit 53, to prompt replacement of the tip tool. The processing unit 53 determines, in accordance with the replacement information obtained by the decision unit 63, whether to make the notification unit 211 make notification or not. That is to say, the notification unit 211 makes notification prompting the replacement of the tip tool in accordance with the replacement information obtained by the decision unit 63.

The restrictor 532 restricts (e.g., prevents) the notification to be made by the notification unit 211 while the attachment part 33 is being driven. For example, the restrictor 532 controls the notification unit 211 to prevent the LED of the notification unit 211 from being turned ON or flashing while the attachment part 33 is being driven.

The processing unit 53 also performs the processing of switching the operation mode of the electric tool section 1. The electric tool section 1 has, as operation modes, at least a working mode and a learning mode. As used herein, the working mode refers to an operation mode when the user performs the operations such as fastening a screw using the electric tool section 1. The working mode is a mode at the time of normal operations, so to speak. The learning mode is an operation mode when a learned model for use to make the decision unit 63 obtain the replacement information indicating whether the tip tool needs replacement or not is created. The learning mode is a mode to be preferably entered, for example, before the electric tool section 1 is used for the first time or before normal operations start to be performed.

The processing unit 53 may switch the operation mode in accordance with an operating command entered by the user via the operating unit 232, for example. Alternatively, the processing unit 53 may switch the operation mode in accordance with an operating command entered via a dip switch, for example, provided separately from the operating unit 232.

### (11) Linkage Device

As shown in FIG. 1, the linkage device 6 includes the communications unit 61, the storage unit 62, and the decision unit 63.

The communications unit 61 includes a communications interface device. The communications unit 61 is ready to communicate with the communications unit 51 of the electric tool section 1 via the communications interface device.

The storage unit 62 is a nonvolatile storage device which may be implemented as, for example, a hard disk drive (HDD) or a solid-state drive (SSD). The storage unit 62 stores the physical quantity measured by the measuring unit 4.

The linkage device 6 includes a computer system including one or more processors and a memory. The decision unit 63 includes the one or more processors of the linkage device 6. The functions of the decision unit 63 are performed by making the one or more processors execute a program stored in the memory. The program may be stored in the memory. Alternatively, the program may also be downloaded via a telecommunications line such as the Internet or distributed after having been stored in a non-transitory storage medium such as a memory card.

The decision unit 63 includes a learner 64 and an inferrer 65. Note that the learner 64 and the inferrer 65 just represent functions to be performed by the decision unit 63 and do not necessarily have a substantive configuration.

The decision unit 63 obtains (generates) replacement information indicating whether the tip tool needs replacement or not. More specifically, the decision unit 63 obtains the replacement information by machine learning.

The learner 64 is in charge of a learning phase for obtaining the replacement information. The learner 64 generates a learned model for obtaining the replacement information.

The inferrer 65 is in charge of an inference phase for obtaining the replacement information. The inferrer 65 obtains the replacement information based on the learned model.

### (12) how to Obtain Replacement Information

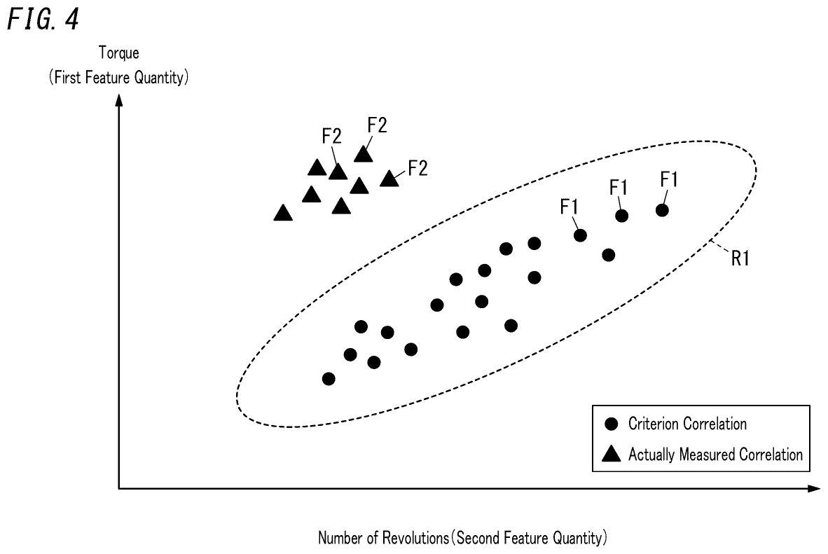

Next, a diagnosis method according to the present disclosure, i.e., the series of processing steps through which the decision unit 63 obtains the replacement information, will be described with reference to FIG. 4.

The decision unit 63 may obtain the replacement information in a regular cycle, for example. Alternatively, the decision unit 63 may obtain the replacement information when receiving a command signal requesting the replacement information.

If the measuring unit 4 has measured a physical quantity in a situation where the operation mode of the electric tool section 1 is the working mode, then the processing unit 53 defines correspondence to indicate that the physical quantity has been detected in the working mode and makes the communications unit 51 transmit information about the physical quantity to the linkage device 6. In the following description, the physical quantity detected in the working mode will be hereinafter referred to as a “physical quantity for decision.” The storage unit 62 of the linkage device 6 stores the physical quantity for decision.

If the operation mode of the electric tool section 1 is the learning mode, then the user who has performed the operations using the electric tool section 1 determines whether it is about time to replace the tip tool or not. Then, the processing unit 53 makes the user enter an answer to the question of whether it is about time to replace the tip tool or not. The user may determine, based on the length of the accumulated period for which the tip tool has been used, the appearance of the tip tool, the workability of the operations using the tip tool, and whether the operations have been done properly, for example, whether it is about time to replace the tip tool or not. Then, the user enters the decision result by operating the operating unit 232, for example. If a decision has been made, based on the user's answer entered, that it is not yet time to replace the tip tool, then the processing unit 53 defines the correspondence between the situation and the physical quantity to indicate that the physical quantity has been detected in the learning mode and that the tip tool is operating properly. As used herein, if the tip tool is operating “properly,” this means that it is not yet time to replace the tip tool (i.e., nothing is wrong with the tip tool). Then, the processing unit 53 makes the communications unit 51 transmit information about the physical quantity to the linkage device 6.

In this embodiment, if a decision has been made, based on the user's answer entered, that it is about time to replace the tip tool, then the processing unit 53 transmits no information about the physical quantity to the linkage device 6. Alternatively, even if the decision has been made that it is about time to replace the tip tool, the processing unit 53 may also define the correspondence between the situation and the physical quantity to indicate that the physical quantity has been detected in the learning mode and that it is about time to replace the tip tool. Then, information about the physical quantity may be transmitted to the linkage device 6. To make the machine learn that it is about time to replace the tip tool, the learning mode may be carried out using a tip tool which has been used to a certain degree. Also, the learning mode may be carried out by either the manufacturer of the linkage device 6 or the manufacturer of the electric tool section 1, not by the user of the electric tool section 1. In that case, information about the physical quantity collected in the learning mode that has been carried out by the manufacturer may be transmitted from the manufacturer's server to the linkage device 6 via an external network such as the Internet. In the following description, the physical quantity detected in the learning mode will be hereinafter sometimes referred to as a “physical quantity for learning.” The storage unit 62 of the linkage device 6 stores the physical quantity for learning.

Unlike the working mode that is a normal operation mode, the decision is preferably made in the learning mode by a person with some skill whether it is about time to replace the tip tool or not. In addition, the decision is preferably made a number of times in advance before the operator is made to perform normal operations.

In addition, each of the plurality of electric tool sections 1, including the electric tool section 1A and the electric tool section 1B, stores the identification information of its own device in the storage unit 52. The processing unit 53 transmits the identification information of its own device to the linkage device 6 in association with the information about the physical quantity. This allows the linkage device 6 to determine, by the identification information, from which electric tool section 1 the linkage device 6 has received the information about the physical quantity.

If the tip tool performs the operations when the operation mode of the electric tool section 1 is the working mode, the processing unit 53 makes the communications unit 51 transmit the physical quantity for decision to the linkage device 6. On receiving the physical quantity for decision, the linkage device 6 automatically determines whether it is about time to replace the tip tool or not. Then, the processing unit 53 receives the result of the decision made by the linkage device 6 and lights the notification unit 211 differently depending on the decision. For example, if the decision indicates that it is about time to replace the tip tool, then the processing unit 53 makes the notification unit 211 flash in red. On the other hand, if the decision indicates that it is not yet time to replace the tip tool (i.e., that the tip tool is operating properly), then the processing unit 53 makes the notification unit 211 continuously lit in green. This allows the user to confirm, by visually checking the lighting state of the notification unit 211, whether it is about time to replace the tip tool or not.

In the learning mode, the storage unit 62 of the linkage device 6 stores the physical quantity for learning. The learner 64 extracts a criterion correlation (to be described later) from the physical quantity for learning. Then, the learner 64 sets criterion information based on the criterion correlation thus extracted and makes the storage unit 62 store the criterion information. In other words, the learner 64 sets the criterion information based on the physical quantity for learning.

Specifically, the learner 64 extracts (acquires), from the physical quantity for learning, a criterion correlation, i.e., a correlation between a plurality of criterion feature quantities which are a plurality of feature quantities of multiple different types and used as criteria for making a decision about the replacement of the tip tool. As used herein, the “plurality of feature quantities of multiple different types” includes a first feature quantity, a second feature quantity, a third feature quantity, a fourth feature quantity, a fifth feature quantity, and a sixth feature quantity. The plurality of criterion feature quantities includes the first through sixth feature quantities extracted from the physical quantity for learning. That is to say, in this embodiment, the number of types of the plurality of feature quantities (type number) is six as an example. However, the number of types of the plurality of feature quantities has only to be two or more and does not have to be six.

The criterion information to be set by the learner 64 includes information about a decision range R1 (refer to FIG. 4) based on a plurality of criterion correlations. The decision range R1 is set by the learner 64 based on the physical quantity for learning which has been measured when a properly operating tip tool is used. The inferrer 65 determines whether the actually measured correlation falls within the decision range R1, thereby determining whether the tip tool needs replacement or not. As used herein, the “actually measured correlation” refers to a correlation between a plurality of actually measured feature quantities. As used herein, the actually measured feature quantity refers to a feature quantity extracted from a physical quantity (i.e., the physical quantity for decision) detected in the working mode.

The learner 64 uses machine learning to set the decision range R1. That is to say, the learner 64 sets the decision range R1 by using a learned model generated by a machine learning algorithm by artificial intelligence (AI). As used herein, the “learned model” refers to a model generated by a computer system based on the learning data (i.e., physical quantity for learning) following a learning program.

The first to third feature quantities according to this embodiment are physical quantities measured by the measuring unit 4. Specifically, the first to third feature quantities are respectively the torque, number of revolutions, and thrust load of the tip tool.

The fourth to sixth feature quantities according to this embodiment are feature quantities based on at least one of the type information about the type of the tip tool or material information about the material for the tip tool. The feature quantities based on at least one of the type information or the material information are feature quantities used in common between the actually measured feature quantities and the criterion feature quantities.

The type information and the material information may be entered via the user's operations, for example, into the operating unit 232 of the electric tool section 1 and transmitted from the electric tool section 1 to the linkage device 6. Alternatively, the type information and the material information may also be entered via the user's operations into the linkage device 6 or from an external terminal (such as a mobile device) outside of the electric tool section 1 into the linkage device 6.

In this embodiment, the criterion correlation between the plurality of criterion feature quantities during the first operation, the criterion correlation between the plurality of criterion feature quantities during the second operation, . . . , and criterion correlation between the plurality of criterion feature quantities during the n^{th} operation are stored in the storage unit 62 to be associated with each other by the unit of each operation. The criterion correlations may be stored in the storage unit 62 in the form of a data table such as the one shown in Table 1.

TABLE 1

| | 1^{st} fastening | 2^{nd} fastening | | n^{th} fastening |
|---|---|---|---|---|
| | operation | operation | . . . | operation |
| 1^{st} feature quantity | A1 | A2 | . . . | An |
| 2^{nd} feature quantity | B1 | B2 | . . . | Bn |
| 3^{rd} feature quantity | C1 | C2 | . . . | Cn |
| 4^{th} feature quantity | D1 | D2 | . . . | Dn |
| 5^{th} feature quantity | E1 | E2 | . . . | En |
| 6^{th} feature quantity | F1 | F2 | . . . | Fn |

Each column of Table 1 corresponds to the criterion correlation between the plurality of criterion feature quantities. For instance, in the example shown in Table 1, the learner 64 extracts, from the physical quantity during the first operation, the criterion correlation indicating that the first feature quantity A1 is correlated with the second feature quantity B1 and that the first feature quantity A1 is correlated with the third feature quantity C1.

In the example shown in Table 1, multiple groups of criterion feature quantities including n sets of criterion correlations are stored in the storage unit 62, where n is a natural number equal to or greater than one. That is to say, multiple groups of criterion feature quantities including one or more sets of criterion correlations are stored in the storage unit 62.

After having stored, in the storage unit 62, the plurality of criterion correlations thus extracted, the learner 64 according to this embodiment calculates a variance-covariance matrix. The variance-covariance matrix according to this embodiment is an exemplary square matrix including a variance and a covariance which are associated with each of the first through sixth feature quantities (a plurality of feature quantities) included in the multiple groups of criterion feature quantities stored in the storage unit 62. The following Table 2 is an exemplary variance-covariance matrix calculated by the learner 64:

TABLE 2

| | 1^{st} feature | | 6^{th} feature |
|---|---|---|---|
| | quantity | . . . | quantity |
| 1^{st} feature quantity | xxx | . . . | yyy |
| . | . . . | . . . | . . . |
| . | . . . | . . . | . . . |
| . | . . . | . . . | . . . |
| 6^{th} feature quantity | yyy | . . . | zzz |

As shown in Table 2, in the variance-covariance matrix, an element at the n^{th} row and the n^{th} column is a variance value of the n^{th} feature quantity, and an element at the n^{th} row and the m^{th} column and an element at the m^{th} row and the n^{th} column are the covariance value of the n^{th} and m^{th} feature quantities, where n and m are numbers equal to or greater than 1 and equal to or less than 6 and are mutually different numbers. For example, in Table 2, the element at the first row and the sixth column and the element at the sixth row and the first column have the same value.

Then, the learner 64 calculates an inverse matrix of the variance-covariance matrix thus calculated and sets a decision range R1 (refer to FIG. 4) in which the Mahalanobis distance represented by d in Equation (1) is equal to or less than a threshold value. In this case, the threshold value may be, for example, a value that has been set in advance by the user. The user may register or change the threshold value that has been set by, for example, operating the operating unit 232. Note that the threshold value is preferably set in a range where all of the plurality of criterion correlations stored in the storage unit 62 fall within the decision range R1. In other words, the threshold value is preferably equal to or greater than the maximum Mahalanobis distance among a plurality of Mahalanobis distances with respect to the plurality of criterion correlations stored in the storage unit 62.

$$d = \sqrt{{( x - μ )}^{T} {\sum }^{- 1} ( x - μ )} \qquad ( 1 )$$

In Equation (1), x is data to be subjected to the decision, i.e., a plurality of actually measured feature quantities (actually measured correlation) extracted from the physical quantity for decision. In Equation (1), Σ⁻¹ is the inverse matrix of the variance-covariance matrix. Also, in Equation (1), u is the average value of the multiple groups of criterion feature quantities stored in the storage unit 62. That is to say, the learner 64 sets the decision range R1 based on the average value of the multiple groups of criterion feature quantities stored in the storage unit 62, the threshold value that has been set in advance by the user, and the inverse matrix of the variance-covariance matrix.

Then, every time the physical quantity for learning is acquired, the learner 64 either sets or updates the criterion information and makes the storage unit 62 store the criterion information that has been set or updated. The criterion information includes the decision range R1 that has been set based on the plurality of criterion correlations. In this embodiment, the criterion information may include, for example, information about the multiple groups of criterion feature quantities extracted by the learner 64, information about the inverse matrix of the variance-covariance matrix calculated by the learner 64, and information about the decision range R1.

The storage unit 62 stores the criterion information that has been set by the learner 64. The criterion information has been set based on the criterion correlation between a plurality of feature quantities of mutually different types which are a plurality of criterion feature quantities used as decision criterion about the replacement of the tip tool.

The decision unit 63 makes a decision about the replacement of the tip tool (i.e., performs the decision step) in accordance with the criterion information stored in the storage unit 62 and the actually measured correlation between the plurality of actually measured feature quantities extracted from the physical quantity for decision. On receiving the physical quantity for decision, the inferrer 65 of the decision unit 63 extracts (acquires), from the physical quantity for decision, a plurality of actually measured feature quantities, which are a plurality of feature quantities of multiple different types and are to be subjected to the decision about the replacement of the tip tool. The respective types of the plurality of actually measured feature quantities correspond to the types of the plurality of criterion feature quantities. That is to say, the plurality of actually measured feature quantities includes first to sixth feature quantities extracted from the physical quantity for decision.

On extracting the actually measured correlation from the physical quantity for decision, the inferrer 65 calculates the Mahalanobis' distance by Equation (1) with reference to the criterion information. Then, the inferrer 65 determines whether the Mahalanobis' distance is equal to or less than the threshold value, i.e., whether the actually measured correlation falls within the decision range R1.

FIG. 4 is a schematic representation illustrating, as a two-dimensional graph having an X-axis (the axis of abscissas) and a Y-axis (the axis of ordinates), the concept of the decision range R1. More specifically, FIG. 4 is a schematic representation illustrating the concept of the decision range R1 as a two-dimensional graph representing a correlation between the first feature quantity (on the axis of ordinates) and the second feature quantity (on the axis of abscissas). Note that although the decision range R1 according to this embodiment may actually be set as six dimensions (corresponding to the first through sixth physical quantities, respectively), the decision range R1 is illustrated in FIG. 4 with attention paid to only two feature quantities, out of the six feature quantities (namely, the first through sixth feature quantities), for the sake of convenience of description and to make the concept easily understandable.

In FIG. 4, each of the plurality of solid circle points F1 (data points) represents a criterion correlation between a plurality of criterion feature quantities. That is to say, each single point F1 represents a correlation between a plurality of (six) criterion feature quantities including the first through sixth feature quantities, respectively. The plurality of points F1 have been extracted from physical quantities for learning which have been detected during mutually different operations. That is to say, the plurality of points F1 represents the multiple groups of criterion feature quantities. Each of the plurality of solid triangular points F2 (data points) represents the actually measured correlation in a state where the tip tool has deteriorated. The plurality of points F2 have been extracted from physical quantities for decision which have been detected during mutually different operations. The decision range R1 is a range where the Mahalanobis' distance is equal to or less than the threshold value. If the actually measured correlation falls outside of the decision range R1 as indicated by the points F2 (i.e., if the Mahalanobis' distance representing the actually measured correlation is greater than the threshold value), then the inferrer 65 decides that the tip tool needs replacement. For example, the inferrer 65 attributes the increase in torque to abnormality with the tip tool and decides that the tip tool needs replacement as shown in FIG. 4. On the other hand, if the actually measured correlation falls within the decision range R1 (i.e., if the Mahalanobis' distance representing the actually measured correlation is equal to or less than the threshold value), then the inferrer 65 decides that the tip tool is operating properly (i.e., the tip tool needs no replacement).

As can be seen, the decision unit 63 obtains the replacement information based on the location of the physical quantity measured by the measuring unit 4 and stored in the storage unit 62 within a feature quantity space (refer to FIG. 4) about a feature quantity extracted from the physical quantity measured by the measuring unit 4 (i.e., depending on whether the actually measured correlation falls within the decision range R1). The replacement information is a piece of information representing a decision result indicating whether the tip tool needs replacement.

In addition, the decision unit 63 according to this embodiment makes a decision about the replacement of the tip tool based on the correlation between a plurality of feature quantities of mutually different types (e.g., the first and second feature quantities in the example shown in FIG. 4). This improves the accuracy of decision compared to a situation where the decision unit 63 makes a decision based on only one type of feature quantity.

After the decision unit 63 has determined whether the tip tool needs replacement or not, the decision unit 63 makes the communications unit 61 transmit replacement information, representing the decision result, to the electric tool section 1. More specifically, the decision unit 63 transmits, based on the identification information associated with the physical quantity information, the decision result to the electric tool section 1 corresponding to the identification information.

### (13) Operation

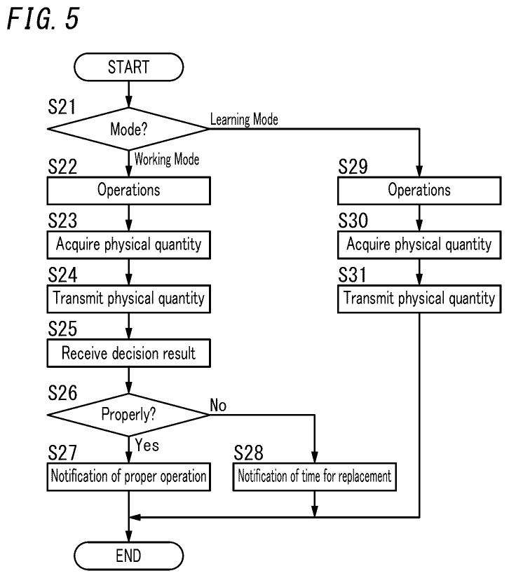

Next, it will be described with reference to FIG. 5 how the electric tool section 1 according to this embodiment operates. The electric tool section 1 checks whether the operation mode is set at the working mode or the learning mode (in S21).

First, a situation where the operation mode of the electric tool section 1 is the working mode (i.e., a situation where the answer to the query of S21 is working mode) will be described. The user performs operations of fastening a screw, for example, using the electric tool section 1 (in S22). Next, the processing unit 53 of the electric tool section 1 acquires the physical quantity detected by the measuring unit 4 during the operations (in S23). The processing unit 53 makes the communications unit 51 transmit information about the physical quantity for decision to the linkage device 6 (in S24). Then, when the communications unit 51 receives the decision result from the linkage device 6 (in S25), the processing unit 53 determines whether the decision result indicates that the tip tool is operating properly (in S26). If the decision result indicates that the tip tool is operating properly (if the answer is YES in S26), the processing unit 53 lights the notification unit 211 in green to make notification that it is not yet time to replace the tip tool (in S27) to end the processing. On the other hand, if the decision result indicates that it is about time to replace the tip tool (if the answer is NO in S26), the processing unit 53 lights the notification unit 211 in red to make notification that it is about time to replace the tip tool (in S28) to end the processing.

Next, a situation where the operation mode of the electric tool section 1 is the learning mode (i.e., a situation where the answer to the query of S21 is learning mode) will be described. The user performs operations of fastening a screw, for example, using the electric tool section 1 (in S29). These operations are supposed to be operations in which the user has decided the tip tool is operating properly. Next, the processing unit 53 of the electric tool section 1 acquires the physical quantity measured by the measuring unit 4 during the operations (in S30). The processing unit 53 makes the communications unit 51 transmit information about the physical quantity for learning to the linkage device 6 (in S31). Then, the electric tool section 1 ends the processing.

Note that the flowchart shown in FIG. 5 shows only an exemplary procedure of operation of the electric tool section 1 and should not be construed as limiting. Optionally, the processing steps shown in FIG. 5 may be performed in a different order as appropriate from the illustrated one, some of the processing steps shown in FIG. 5 may be omitted as appropriate, and/or an additional processing step may be performed as needed. For example, the processing step S21 of checking the operation mode of the electric tool section 1 may be performed after the operations have been performed by the electric tool section 1 (in S22; S29) or after the physical quantity has been acquired by the processing unit 53 (in S23; S30).

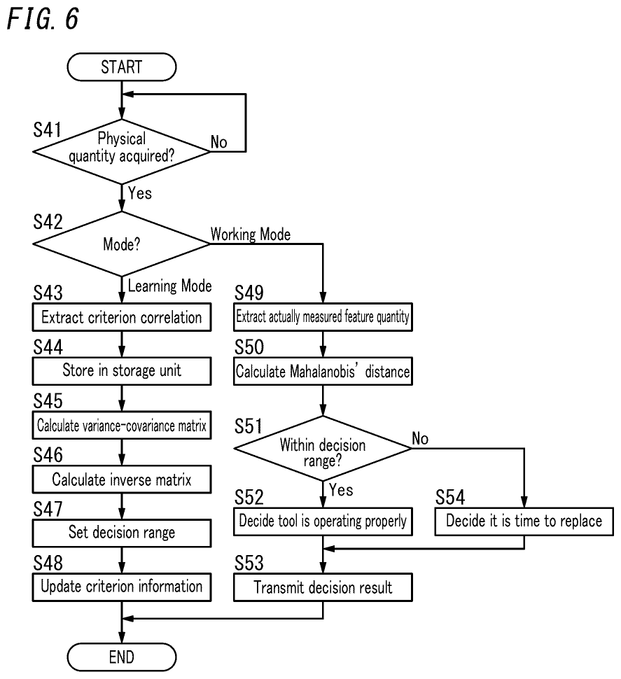

Next, it will be described with reference to FIG. 6 how the linkage device 6 according to this embodiment operates. The linkage device 6 checks whether the communications unit 61 has acquired any physical quantity from the electric tool section 1 (in S41). If the communications unit 61 has acquired no physical quantities (if the answer is NO in S41), the linkage device 6 performs this processing step S41 repeatedly until the communications unit 61 acquires a physical quantity. On the other hand, if the communications unit 61 has acquired any physical quantity (if the answer is YES in S41), then the decision unit 63 determines (or checks) whether the mode associated with the physical quantity is the learning mode or the working mode (in S42).

If the result of the mode decision is the learning mode (i.e., if the answer to the query of S42 is learning mode), then the communications unit 61 outputs the physical quantity for learning to the learner 64 and the learner 64 extracts a criterion correlation between a plurality of criterion feature quantities from the physical quantity for learning (in S43). Then, the learner 64 stores the plurality of criterion feature quantities as criterion information in the form of a data table, for example, in the storage unit 62 (in S44). Next, the learner 64 calculates a variance-covariance matrix of the multiple groups of criterion feature quantities in the storage unit 62 (in S45) and further calculates an inverse matrix of the variance-covariance matrix (in S46). Then, the learner 64 sets a decision range R1 based on the average value of the multiple groups of criterion feature quantities stored in the storage unit 62, a threshold value set in advance by the user, and the inverse matrix of the variance-covariance matrix (in S47). After having set the decision range R1, the learner 64 sets (updates) the criterion information (in S48) to end the processing.

The series of processing steps S43-S48 is an exemplary learning phase. By performing the learning phase, the linkage device 6 extracts a criterion correlation between the plurality of criterion feature quantities from the physical quantity for learning and initializes (or updates) the criterion information to have the criterion information stored in the storage unit 62.

On the other hand, if the result of the mode decision in the processing step S42 is the working mode (i.e., if the answer to the query of S42 is working mode), then the communications unit 61 outputs the physical quantity for decision to the inferrer 65 and the inferrer 65 extracts the actually measured correlation between the plurality of actually measured feature quantities from the physical quantity for decision (in S49). The inferrer 65 calculates, by reference to the criterion information obtained by the learning processing, a Mahalanobis' distance using the average value of the multiple groups of criterion feature quantities stored in the storage unit 62, the inverse matrix of the variance-covariance matrix, and the plurality of actually measured feature quantities (in S50). Then, the inferrer 65 checks whether the Mahalanobis' distance thus calculated is equal to or less than a threshold value, i.e., whether the actually measured correlation between the plurality of actually measured feature quantities falls within the decision range R1 (in S51). If the actually measured correlation falls within the decision range R1 (if the answer is YES in S51), then inferrer 65 decides that the tip tool is operating properly, i.e., it is not yet time to replace the tip tool (in S52) and transmits a decision result indicating to that effect (in S53) to end the processing. On the other hand, if the actually measured correlation falls outside of the decision range R (if the answer is NO in S51), the inferrer 65 decides that it is about time to replace the tip tool (in S54) and transmits a decision result to that effect (in S53) to end the processing.

The series of processing steps S49-S54 is an exemplary inference phase performed by the inferrer 65. Also, the series of processing steps S43-S54 are an exemplary decision step performed by the decision unit 63.

Note that the flowchart shown in FIG. 6 shows only an exemplary procedure of operation of the electric tool section 1 and should not be construed as limiting. Optionally, the processing steps shown in FIG. 6 may be performed in a different order as appropriate from the illustrated one, some of the processing steps shown in FIG. 6 may be omitted as appropriate, and/or an additional processing step may be performed as needed. For example, Steps S45-S48 in the learning mode may be performed after Step S49 in the working mode.

Optionally, the criterion information may have been set initially in advance while either the electric tool section 1 or the linkage device 6 was manufactured and shipped. That is to say, the user who uses the electric tool section 1 does not have to set the criterion information with the electric tool section 1 set at the learning mode on the spot where he or she is performing the actual operations, for example. Nevertheless, if the user is made to set the criterion information initially and update (i.e., make re-learning about) the criterion information through the electric tool section 1, then the criterion information will be more suitable to the environment where he or she uses the electric tool section 1.

In this embodiment, the communications unit 61 serves as the acquirer 610 (refer to FIG. 1). The acquirer 610 acquires at least one of type information about the type of the tip tool or material information about the material for the tip tool. The decision unit 63 obtains the replacement information based on the physical quantity stored in the storage unit 62 and at least one of the type information or the material information acquired by the acquirer 610. More specifically, the decision unit 63 obtains an actually measured feature quantity and the criterion feature quantity based on the at least one piece of information, uses the criterion feature quantity to define the decision range R1, and obtains the replacement information based on the actually feature quantity and the decision range R1. Using the type information and the material information allows the effect of the type information and the material information on the magnitude of the torque of the tip tool, for example, to be reflected on the determination about whether the tip tool needs replacement or not.

### (First Variation)

Next, a first variation of the exemplary embodiment will be described.

In the exemplary embodiment described above, the measuring unit 4 includes the torque measuring unit 41, the number of revolutions measuring unit 42, and the thrust load measuring unit 43 for measuring, as the physical quantity, a thrust load applied to the tip tool. The storage unit 62 stores, as respective physical quantities, the torque measured by the torque measuring unit 41, the number of revolutions measured by the number of revolutions measuring unit 42, and the thrust load measured by the thrust load measuring unit 43. The decision unit 63 obtains the replacement information based on the torque, the number of revolutions, and the thrust load that are stored in the storage unit 62.

Alternatively, the physical quantity measured by the measuring unit 4 may also be one or two selected from the group consisting of the torque, the number of revolutions, and the thrust load, for example. Thus, for example, the measuring unit 4 may include at least one of the torque measuring unit 41 for measuring, as the physical quantity, torque applied to the tip tool or the number of revolutions measuring unit 42 for measuring, as the physical quantity, the number of revolutions of the tip tool. In that case, the decision unit 63 obtains the replacement information based on at least one of the torque measured by the torque measuring unit 41 and stored in the storage unit 62 or the number of revolutions measured by the number of revolutions measuring unit 42 and stored in the storage unit 62.

Furthermore, the physical quantity measured by the measuring unit 4 is not limited to the torque, number of revolutions, and thrust load. Alternatively, the physical quantity measured by the measuring unit 4 may include, for example, a physical quantity concerning the vibration of either the tip tool or the attachment part 33 (e.g., the magnitude of the vibration).

In the exemplary embodiment described above, the number of the physical quantities measured by the measuring unit 4 is three, namely, torque, number of revolutions, and thrust load. Alternatively, the number of the physical quantities measured by the measuring unit 4 may also be one, two, or four or more.

### (Other Variations of Embodiment)

Next, other variations of the exemplary embodiment will be enumerated one after another. Note that the variations to be described below may be adopted in combination as appropriate. Alternatively, the variations to be described below may also be adopted as appropriate in combination with the first variation described above.

The decision unit 63 does not have to use the physical quantity measured by the measuring unit 4 as the feature quantity as it is but may extract a different feature quantity based on the physical quantity.

The threshold value for use to set the decision range R1 may be set by the learner 64 instead of being set by the user. For example, the learner 64 may set the decision range R1 using, as a threshold value, the maximum Mahalanobis' distance out of the plurality of Mahalanobis' distances of the plurality of criterion correlations stored in the storage unit 62. Alternatively, the learner 64 may set the decision range R1 with the maximum Mahalanobis' distance used as a criterion. The threshold value for use to set the decision range R1 may be obtained by, for example, multiplying the maximum Mahalanobis' distance by a predetermined coefficient.

The criterion information does not have to be a piece of information obtained from the physical quantity when the tip tool is operating properly. For example, if the tip tool that was used in the past is the same as the tip tool used currently, the degree of abnormality of the tip tool would have been smaller in the past than in the present, and therefore, the criterion information may also be a piece of information obtained from the physical quantity that was measured in the past.

In the embodiment described above, the Mahalanobis' distance is supposed to be used as a cluster analysis technique, i.e., as a “distance” from a group of normal data. However, this is only an example and should not be construed as limiting. Alternatively, the decision unit 63 may also determine, based on the correlation between two or more feature quantities, selected from a plurality of feature quantities of multiple different types, without using the Mahalanobis' distance, whether the tip tool needs replacement or not.

In the exemplary embodiment described above, the processing of obtaining the replacement information is performed by the linkage device 6. Alternatively, the processing of obtaining the replacement information may also be performed by the processing unit 53 of the electric tool section 1.

The transmission part 32 does not have to include the impact mechanism.

The notification unit 211 does not have to be configured to make visual notification for the user. Alternatively, the notification unit 211 may also make notification either as a sound (such as a voice) or vibration. Still alternatively, the notification unit 211 may also be implemented as, for example, a transmitter for transmitting a notification signal to an external terminal device (such as a mobile device) outside of the electric tool section 1.

The linkage device 6 may include the notification unit 211.

The notification unit 211 for making notification based on the replacement information is not an essential constituent element for the electric tool system 100. The electric tool system 100 may store, in the storage unit 62, the replacement information obtained by the decision unit 63, for example. Optionally, the replacement information may also be used for a computer system to create a management (such as placing an order and replacement) plan of the tip tool, for example.

The electric tool system 100 according to the present disclosure or the agent that performs the diagnosis method according to the present disclosure includes a computer system. The computer system may include a processor and a memory as principal hardware components thereof. The computer system performs at least some of the functions of the electric tool system 100 according to the present disclosure or serves as the agent that performs the diagnosis method according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Optionally, the plurality of functions of the linkage device 6 may be distributed in multiple devices. Furthermore, at least some functions of the linkage device 6 may be implemented as either a server or a cloud computing system.

Furthermore, the constituent elements of the electric tool system 100 may be distributed in multiple devices. For example, the electric tool section 1 including at least the activating unit 3 may be provided separately from at least one of the measuring unit 4, the communications unit 51, the storage unit 52, the notification unit 211, the presentation unit 231, or the processing unit 53.

Furthermore, at least some functions of the electric tool system 100 which are distributed in the linkage device 6 and the electric tool section 1 in the exemplary embodiment described above may be aggregated together in a single device. For example, in the exemplary embodiment described above, the linkage device 6 is provided separately from the electric tool section 1 and the linkage device 6 includes the decision unit 63. Alternatively, the electric tool section 1 may include the decision unit 63. In that case, the linkage device 6 does not have to be one of constituent elements of the electric tool system 100. Still alternatively, the electric tool section 1 may have some functions of the decision unit 63 (such as the function of the learner 64).

### (Recapitulation)

The exemplary embodiment and its variations described above are specific implementations of the following aspects of the present disclosure.

An electric tool system (100) according to a first aspect includes an electric tool section (1), a measuring unit (4), a storage unit (62), and a decision unit (63). The electric tool section (1) is portable. The electric tool section (1) includes a driving part (31), an attachment part (33), and a transmission part (32). The driving part (31) is supplied with motive power by a power source (P11) and thereby generates torque. A tip tool is attachable to the attachment part (33). The transmission part (32) transmits the torque from the driving part (31) to the attachment part (33) and thereby drives the attachment part (33). The measuring unit (4) measures a physical quantity concerning the electric tool section (1). The storage unit (62) stores the physical quantity measured by the measuring unit (4). The decision unit (63) determines, based on the physical quantity stored in the storage unit (62), whether the tip tool needs replacement or not and thereby obtains replacement information representing a decision result indicating whether the tip tool needs replacement or not.

This configuration allows the user, for example, to determine, by reference to the replacement information, whether the wear of the tip tool, for example, has caused any decline in the efficiency of operations being performed using the electric tool section (1), thus reducing the chances of causing a decline in the efficiency of operations.

An electric tool system (100) according to a second aspect, which may be implemented in conjunction with the first aspect, further includes a notification unit (211). The notification unit (211) makes, in accordance with the replacement information obtained by the decision unit (63), notification prompting replacement of the tip tool.

This configuration allows the user, for example, to determine whether the tip tool needs replacement or not.

An electric tool system (100) according to a third aspect, which may be implemented in conjunction with the second aspect, further includes a restrictor (532). The restrictor (532) restricts, while the attachment part (33) is being driven, the notification to be made by the notification unit (211).

This configuration may reduce the chances of causing, while the operator is performing operations using the electric tool section (1), the notification made by the notification unit (211) to attract the operator's attention and thereby disturb the operator in his or her operations.

In an electric tool system (100) according to a fourth aspect, which may be implemented in conjunction with any one of the first to third aspects, the measuring unit (4) includes at least one of a torque measuring unit (41) or a number of revolutions measuring unit (42). The torque measuring unit (41) measures, as the physical quantity, torque applied to the tip tool. The number of revolutions measuring unit (42) measures, as the physical quantity, a number of revolutions of the tip tool.

This configuration allows the decision unit (63) to more accurately obtain replacement information indicating whether the tip tool needs replacement or not.

In an electric tool system (100) according to a fifth aspect, which may be implemented in conjunction with the fourth aspect, the measuring unit (4) includes the torque measuring unit (41), the number of revolutions measuring unit (42), and a thrust load measuring unit (43). The thrust load measuring unit (43) measures, as the physical quantity, a thrust load applied to the tip tool. The decision unit (63) obtains the replacement information based on the torque, the number of revolutions, and the thrust load which are stored in the storage unit (62).

This configuration allows the decision unit (63) to more accurately obtain replacement information indicating whether the tip tool needs replacement or not.

An electric tool system (100) according to a sixth aspect, which may be implemented in conjunction with any one of the first to fifth aspects, further includes an acquirer (610). The acquirer (610) acquires at least one of type information about a type of the tip tool or material information about a material for the tip tool. The decision unit (63) obtains the replacement information based on the physical quantity stored in the storage unit (62) and at least one of the type information or the material information acquired by the acquirer (610).

This configuration allows the decision unit (63) to more accurately obtain replacement information indicating whether the tip tool needs replacement or not.

In an electric tool system (100) according to a seventh aspect, which may be implemented in conjunction with any one of the first to sixth aspects, the decision unit (63) obtains the replacement information based on a storage location of the physical quantity in the storage unit (62) within a feature quantity space about a feature quantity extracted from the physical quantity.

This configuration allows the decision unit (63) to more accurately obtain replacement information indicating whether the tip tool needs replacement or not.

In an electric tool system (100) according to an eighth aspect, which may be implemented in conjunction with any one of the first to seventh aspects, the measuring unit (4) measures a plurality of physical quantities concerning the electric tool section (1). The plurality of physical quantities includes the physical quantity. The storage unit (62) stores the plurality of physical quantities measured by the measuring unit (4). The decision unit (63) obtains the replacement information based on a correlation between the plurality of physical quantities stored in the storage unit (62).

This configuration allows the decision unit (63) to more accurately obtain replacement information indicating whether the tip tool needs replacement or not.

Note that the constituent elements according to the second to eighth aspects are not essential constituent elements for the electric tool system (100) but may be omitted as appropriate.

A diagnosis method according to a ninth aspect is a method for making a diagnosis about an electric tool section (1) which is portable. The electric tool section (1) includes a driving part (31), an attachment part (33), and a transmission part (32). The driving part (31) is supplied with motive power by a power source (P11) and thereby generates torque. A tip tool is attachable to the attachment part (33). The transmission part (32) transmits the torque from the driving part (31) to the attachment part (33) and thereby drives the attachment part (33). The diagnosis method includes a storing step and a decision step. The storing step includes storing, in a storage unit (62), a physical quantity concerning the electric tool section (1) which has been measured by a measuring unit (4). The decision step includes determining, based on the physical quantity stored in the storage unit (62), whether the tip tool needs replacement or not and thereby obtaining replacement information representing a decision result indicating whether the tip tool needs replacement or not.

This method allows the user, for example, to determine, by reference to the replacement information, whether the wear of the tip tool, for example, has caused any decline in the efficiency of operations being performed using the electric tool section (1), thus reducing the chances of causing a decline in the efficiency of operations.

A program according to a tenth aspect is designed to cause one or more processors of a computer system to perform the diagnosis method according to the ninth aspect.

This program allows the user, for example, to determine, by reference to the replacement information, whether the wear of the tip tool, for example, has caused any decline in the efficiency of operations being performed using the electric tool section (1), thus reducing the chances of causing a decline in the efficiency of operations.

Note that these are not the only aspects of the present disclosure but various configurations (including variations) of the electric tool system (100) according to the exemplary embodiment described above may also be implemented as, for example, a diagnosis method, a (computer) program, or a non-transitory storage medium on which the program is stored.

### REFERENCE SIGNS LIST

1 Electric Tool Section
4 Measuring Unit
31 Driving Part
32 Transmission Part
33 Attachment Part
41 Torque Measuring Unit
42 Number of Revolutions Measuring Unit
43 Thrust Load Measuring Unit
62 Storage Unit
63 Decision Unit
100 Electric Tool System
211 Notification Unit
532 Restrictor
610 Acquirer
P11 Power Source

1. An electric tool system comprising:
an electric tool section which is portable,
a measuring unit,
a storage unit, and
a decision unit,
the electric tool section including:
a driving part configured to be supplied with motive power by a power source and thereby generate torque;
an attachment part to which a tip tool is attachable; and
a transmission part configured to transmit the torque from the driving part to the attachment part and thereby drive the attachment part,
the measuring unit being configured to measure a physical quantity concerning the electric tool section,
the storage unit being configured to store the physical quantity measured by the measuring unit,
the decision unit being configured to determine, based on the physical quantity stored in the storage unit, whether the tip tool needs replacement or not and thereby obtain replacement information representing a decision result indicating whether the tip tool needs replacement or not.

2. The electric tool system of claim 1, further comprising a notification unit configured to make, in accordance with the replacement information obtained by the decision unit, notification prompting replacement of the tip tool.

3. The electric tool system of claim 2, further comprising a restrictor configured to restrict, while the attachment part is being driven, the notification to be made by the notification unit.

4. The electric tool system of claim 1, wherein
the measuring unit includes at least one of:
a torque measuring unit configured to measure, as the physical quantity, torque applied to the tip tool; or
a number of revolutions measuring unit configured to measure, as the physical quantity, a number of revolutions of the tip tool.

5. The electric tool system of claim 4, wherein
the measuring unit includes: the torque measuring unit; the number of revolutions measuring unit; and a thrust load measuring unit configured to measure, as the physical quantity, a thrust load applied to the tip tool, and
the decision unit is configured to obtain the replacement information based on the torque, the number of revolutions, and the thrust load which are stored in the storage unit.

6. The electric tool system of claim 1, further comprising an acquirer configured to acquire at least one of type information about a type of the tip tool or material information about a material for the tip tool, wherein
the decision unit is configured to obtain the replacement information based on the physical quantity stored in the storage unit and at least one of the type information or the material information acquired by the acquirer.

7. The electric tool system of claim 1, wherein
the decision unit is configured to obtain the replacement information based on a storage location of the physical quantity in the storage unit within a feature quantity space about a feature quantity extracted from the physical quantity.

8. The electric tool system of claim 1, wherein
the measuring unit is configured to measure a plurality of physical quantities concerning the electric tool section and including the physical quantity,
the storage unit is configured to store the plurality of physical quantities measured by the measuring unit; and
the decision unit is configured to obtain the replacement information based on a correlation between the plurality of physical quantities stored in the storage unit.

9. A diagnosis method for making a diagnosis about an electric tool section, the electric tool section being portable,
the electric tool section including:
a driving part configured to be supplied with motive power by a power source and thereby generate torque;
an attachment part to which a tip tool is attachable; and
a transmission part configured to transmit the torque from the driving part to the attachment part and thereby drive the attachment part,
the diagnosis method comprising:
a storing step including storing, in a storage unit, a physical quantity concerning the electric tool section which has been measured by a measuring unit; and
a decision step including determining, based on the physical quantity stored in the storage unit, whether the tip tool needs replacement or not and thereby obtaining replacement information representing a decision result indicating whether the tip tool needs replacement or not.

10. A non-transitory storage medium storing thereon a program designed to cause one or more processors of a computer system to perform the diagnosis method of claim 9.
